(19) United States
(12) Patent Application Publication
(10) Pub. No.: US 2006/0207323 A1
(43) Pub. Date: Sep. 21, 2006

(54) Float

(76) Inventor: Gunnter Rauchhaus, Raunheim (DE)

Correspondence Address: MAYER, BROWN, ROWE & MAW LLP, P.O. BOX 2828, CHICAGO, IL, 60690-2828, US

(21) Appl. No.: 10/573,865

(22) PCT Filed: Aug. 20, 2004
(86) PCT No.: PCT/EP04/51862

§ 371 Date: Mar. 29, 2006

(30) Foreign Application Priority Data
Sep. 30, 2003 (DE) 10345885.9

(51) Int. Cl. G01F 23/30

(52) U.S. Cl. 73/305

(57) ABSTRACT

The invention relates to a float (8) for a level indicator (3), the float consisting of a casing that surrounds a hollow cavity and a receptacle (16, 16′) for a lever arm (7) of the level indicator (3). The float is configured from at least two interconnected shells (9, 9′), which when joined together form at least two separate chambers (13, 20-22).

### BACKGROUND OF THE INVENTION

The subject matter of the invention is a float for a level indicator, with a casing which surrounds a hollow cavity. Floats of this type are used in level indicators of motor vehicles.

It is known to determine the level in fuel tanks of motor vehicles by means of level indicators having a float. The float of such level indicators is fastened pivotably for this purpose to a lever arm. In order to be suitable as a float, the float has to have sufficient buoyancy. In this case, the buoyancy has to be greater than the weight of the float and of the lever arm. Making this more difficult is the fact that fuel only has a density of approx. 0.7 g/cm³. In order therefore to compensate for the weight of the lever arm, the float has to have a density of significantly below 0.7 g/cm³. In addition, the float has to be composed of a fuel-resistant material.

There are currently a small number of plastics which are firstly fuel-resistant and secondly have such a low density that they can be used as floats. However, these plastics are very expensive. The low density of these plastics is often only achieved by complex processing of the plastics, for example foaming. Due to this, floats of this type are very cost-intensive to produce.

A further possibility of obtaining a float with sufficient buoyancy is to use a hollow body. In this case, a casing encloses a hollow cavity, with the volume of the float displacing such an amount of fuel that the hollow body floats. Floats composed of metal are already known. However, their relatively large dimensions which they have to have due to their relatively high specific weight are disadvantageous. In addition, the welding or soldering of the float parts is expensive.

Furthermore, plastic floats designed as hollow bodies are known. The lower specific weight of plastics in comparison with metal permits smaller dimensions and the joining of the individual float parts is substantially more favorable on account of the lower melt temperatures. Since these plastics only have to be fuel-resistant, cost-effective plastics can be used. However, for safety reasons it has not been possible for these floats to be accepted. The fuel in the fuel tank and therefore also the float are permanently in motion because of the dynamics of the vehicle movement. This has the consequence that the float comes into contact with the wall of the tank or with other components in the fuel tank. The forces occurring during these contacts may result in the float being damaged. In the worst case, a leak may occur in the casing of the float. Fuel may penetrate through the leak into the float, as a result of which the latter loses its buoyancy, which results in the lever indicator failing.

The present invention is therefore based on the object of providing a float, which is designed as a hollow body and is composed of a cost-effective plastic, which does not lose its buoyancy even in the event of damage.

### BRIEF DESCRIPTION OF THE INVENTION

According to the invention, the object is achieved in that the casing comprises at least two interconnected parts which, when joined together, form at least two separate chambers.

The effect achieved by the separate chambers is that, in the event of one chamber being damaged, just one chamber fills up with fuel rather than the entire hollow cavity which is enclosed by the float. In this manner, the loss of buoyancy of the float is reduced. The float buoyancy that still remains is therefore sufficient in order to avoid the level indicator failing.

In the simplest case, the float has two separate chambers. However, the loss of buoyancy in the event of damage can be further reduced if the float has more than two chambers.

The shells for the float are simple to produce if all of the chambers are identical in size.

The loss of buoyancy as a consequence of a leak can be reduced further if the chambers with which the float comes into contact with the tank wall or other components in the fuel tank are designed to be smaller than the other chambers. Therefore, only a small volume is flooded while the remaining chambers retain their buoyancy. When designing the float, small chambers can therefore be arranged in a specific manner in the regions in which there needs to be preparation for shocklike loadings on account of the float striking against other components due to movements of liquid in the fuel tank.

The production of the shell parts turns out to be particularly favorable if the two shell parts are identical. The shell parts can thereby be produced using just one die. Owing to these symmetrical designs, the chamber-forming bulges are present in every shell part.

In a further advantageous refinement, the chamber-forming bulges are only present in one shell part. The chamber-delimiting partitions are guided into the region of the separating plane between the two shells. This permits the design of the other shell part as a flat cover, so that the chambers of the float are formed by fitting the cover on the edge and by the partitions of the other shell part.

The shell parts can be manufactured particularly favorably from fuel-resistant plastic. In particular, polyoxymethylene (POM), polyphenylene sulfide (PPS) or polyamide (PA) can readily be produced by means of injection molding.

For a liquid-tight connection of the shell parts welding or adhesive bonding have proven favorable. In the case of welding, those surfaces of the shell parts which come into contact with each other are heated to their softening temperature and are subsequently connected to each other.

In addition to connections with a cohesive material joint, interlocking connections have also proven suitable. In this case, the shell parts are clipped to one another. The swelling of the plastic ensures that the connection of the shell parts is liquid-tight.

In order to fasten the float to the lever arm of the level indicator, a receptacle for the lever arm is arranged on one of the shell parts. If the float is composed of identical shell parts, the receptacle is designed in such a manner that each shell part has one part of the receptacle and the receptacle is formed when the shell parts are joined together.

In order to ensure that the float is always aligned parallel to the tank floor irrespective of the level in the fuel tank, the lever arm is mounted rotatably on the float. So that the play necessary for this and possible tolerances of the lever arm can be compensated for, the lever arm is mounted in the float by means of a bushing.

### BRIEF DESCRIPTION OF THE DRAWINGS

The invention is explained in more detail with reference to a number of exemplary embodiments. In the drawing

FIG. 1 shows a feed unit with the float according to the invention.

FIG. 2 shows the float from FIG. 1.

FIG. 3 shows an exploded illustration of the float from FIG. 2.

FIGS. 4, 4a show illustrations of the float, in a second embodiment.

FIG. 5 shows a third embodiment of the float.

### DETAILED DESCRIPTION OF THE INVENTION

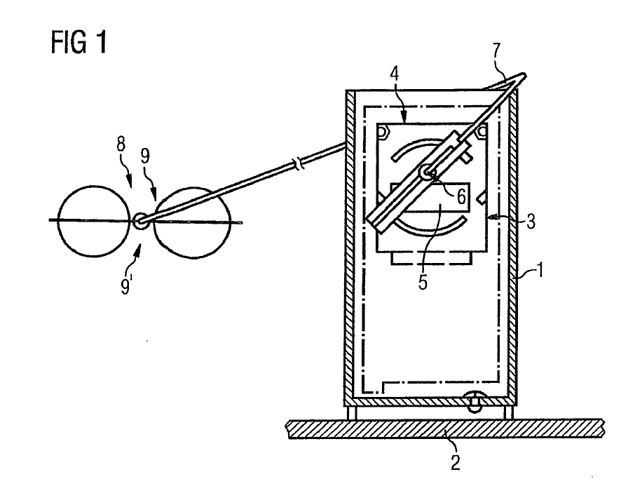

FIG. 1 shows a feed unit 1 in a fuel tank 2. The feed unit 1 bears a level indicator 3. The level indicator 3 comprises a support 4 on which a resistance network 5 is arranged. Sliding contacts (not illustrated) slide on the resistance network 5, as a result of which an electric signal corresponding to the level is obtained. The sliding contacts are fastened to a clip 6 which at the same time bears the lever arm 7. The clip 6 is mounted rotatably in the support 4. At its end facing away from the clip 6, the lever arm 7 has a float 8. The float 8 is composed of two half shells 9, 9′ welded to each other.

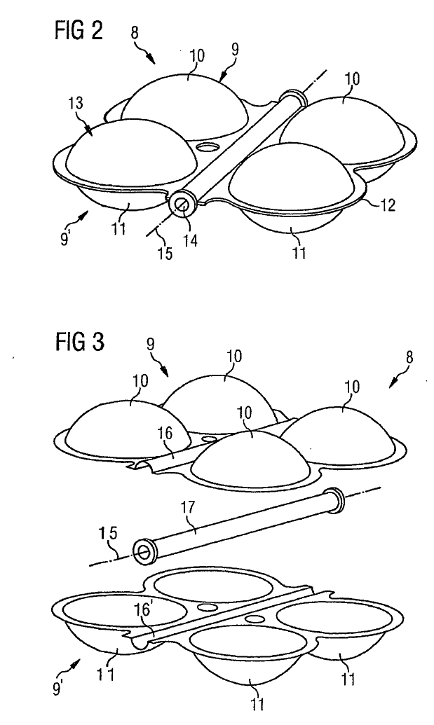

FIG. 2 illustrates the float 8 perspectively. Each of the two half shells 9, 9′ has four spherical bulges 10, 11 which are arranged at a distance from one another in the region of the separating plane 12 between the half shells 9, 9′. Each of the bulges 10 forms a chamber 13 with the opposite bulge 11 of the other half shell 9, 9′. The float 8 furthermore has a hole 14 in which the lever arm (not illustrated) is mounted, so that the float 8 can be rotated about an axis 15 running along the hole 14.

FIG. 3 shows the construction of the float 8. The half shells 9, 9′ with the respective semispherical bulges 10, 11 are composed of PPS. In addition to the bulges 10, 11, each half shell 9, 9′ has a receptacle 16, 16′ running along the axis 15. A bushing 17 of POM is placed into the receptacles 16, 16′. A respective collar integrally formed at both ends of the bushing 17 prevents the bushing 17 from slipping out of the float 8. A lever arm is mounted in the bushing 17.

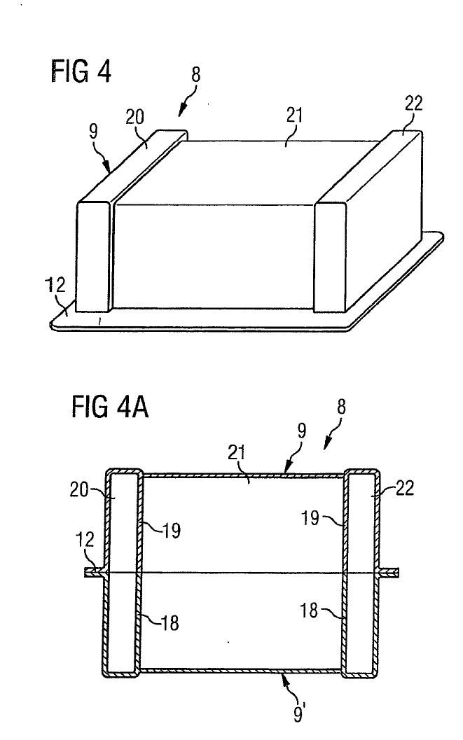

FIGS. 4, 4a show a float shell 9 and a float 8 in section. Partitions 18, 19 which extend into the region of the separating plane 12 are formed in both half shells 9, 9′. In the joined together state, opposite partitions 18, 19 are connected to each other, so that a plurality of chambers 20, 22 are formed. While the chambers 20-22 have a small volume and a large vertical extent, the chamber 21 has a substantially larger volume with a smaller vertical height. The chambers 20, 22 are arranged in regions at which the float 8 can come into contact with other components, for example the fuel tank 2, feed unit 1, in the event of violent deflections. Should damage to the chambers 20, 22 occur during these contacts, fuel penetrates into these chambers 20, 22. The associated loss of buoyancy for the float 8 is negligible owing to their small volume. By contrast, the volume of the chamber 21 is sufficiently large in order to provide the float 8 with sufficient buoyancy in spite of the fuel-filled chambers 20, 22.

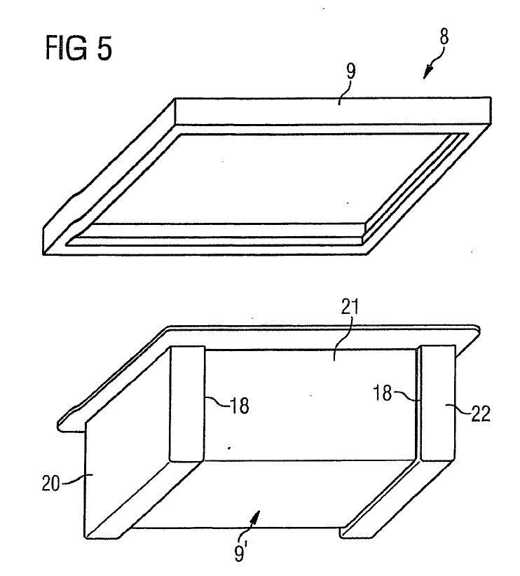

FIG. 5 shows a further refinement of the float 8, with one shell 9 being designed as a cover which closes the other half shell 9′. In contrast to the float 8 in FIGS. 4, 4a with symmetrically designed half shells 9, 9′, the shells 9, 9′ in FIG. 5 are constructed asymmetrically. The cover 9 is of planar design. The partitions 18 are arranged exclusively on the half shell 9′.

On account of its designs, the cover 9 rests on the partitions 18, thus forming the chambers 20-22. The two shells 9, 9′ are joined together by the cover 9 being clipped onto the shell 9′. The swelling behavior of plastic ensures a liquid-tight connection of the two shells 9, 9′ in this case, so that fuel cannot penetrate into the chambers 20-22.

1. Float for a level indicator, comprising a casing which surrounds a hollow cavity and with a receptacle for a lever arm of the level indicator, characterized in that the float (8) of at least two interconnected shells (9, 9′) which, when joined together, form at least two separate chambers (13, 20-22).

2. The float as claimed in claim 1, characterized in that the chambers (13) are identical in size.

3. The float as claimed in claim 1, characterized in that the chambers (20, 22) which come into contact with other parts (1, 2) are smaller than the chambers (21) which do not come into contact with other parts (1, 2).

4. The float as claimed in claim 1, characterized in that the shells (9, 9′) are formed symmetrically.

5. The float as claimed in claim 1, characterized in that the bulges (10, 11) forming the chambers (20-22) are formed in one shell (9′).

6. The float as claimed in claim 1, characterized in that the shells (9, 9′) are welded or adhesively bonded to each other.

7. The float as claimed in claim 6, wherein the shells (9, 9′) are clipped to each other or inserted one into the other.

8. The float as claimed in claim 6, wherein at least one of the shells (9, 9′) has a receptacle (16, 16′) for a lever arm (7).

9. The float as claimed in claim 6, wherein the shells (9, 9′) are composed of POM, PA or PPS.
